(19) United States
(12) Patent Application Publication
(10) Pub. No.: US 2011/0199323 A1
(43) Pub. Date: Aug. 18, 2011

(54) TOUCH SENSING METHOD AND SYSTEM USING THE SAME

(75) Inventors: Ching-Chun Lin, Taipei County (TW); Wing-Kai Tang, Hsinchu City (TW); Hao-Jan Huang, Hsinchu City (TW); Ching-Ho Hung, Hsinchu City (TW); Tsen-Wei Chang, Taichung County (TW); Jiun-Jie Tsai, Hsinchu City (TW)

(73) Assignee: NOVATEK MICROELECTRONICS CORP., Hsinchu (TW)

(21) Appl. No.: 13/018,402

(22) Filed: Jan. 31, 2011

(30) Foreign Application Priority Data
Feb. 12, 2010 (TW) 99104812

(51) Int. Cl. G06F 3/041

(52) U.S. Cl. 345/173; 178/18.03

(57) ABSTRACT

A touch sensing system includes a touch interface and a control unit. The touch interface senses at least one area change generated on the touch interface by at least one object. The control unit defines a touch gesture corresponding to the at least one object according to the at least one area change, so as to perform a touch operation according to the touch gesture. On the other hand, a touch sensing method is also provided. For users, the touch sensing method in the invention employs a pseudo three-dimensional touch sensing technology, such that applications of the touch sensing technology become more diverse.

### CROSS-REFERENCE TO RELATED APPLICATION

This application claims the priority benefit of Taiwan application serial no. 99104812, filed on Feb. 12, 2010. The entirety of the above-mentioned patent application is hereby incorporated by reference herein and made a part of this specification.

### BACKGROUND OF THE INVENTION

1. Field of the Invention

The invention relates to a sensing method and a system using the same. More particularly, the invention relates to a touch sensing method and a system using the same.

2. Description of Related Art

In this information era, reliance on electronic products is increasing day by day. The electronic products including notebook computers, mobile phones, personal digital assistants (PDAs), digital walkmans, and so on are indispensable in our daily lives. Each of the aforesaid electronic products has an input interface for a user to input his or her command, such that an internal system of each of the electronic products spontaneously runs the command.

Manufacturers aiming to provide a humanized operating model thus start to equip the electronic products with touch interfaces, e.g. touch pads or touch panels, such that users are allowed to input commands through the touch pads or the touch panels. At present, the users' commands are frequently given to the electronic products by physical contact or sensing relationship between users' fingers or styluses and the touch interfaces. Thereby, touch gestures of the users can be defined by the electronic products based on variations of coordinates of touch points or increase or decrease in the number of the touch points. As such, corresponding operations can be performed according to the touch gestures.

### SUMMARY OF THE INVENTION

The invention is directed to a touch sensing method by which a touch gesture is defined based on an area change generated when an object touches a touch interface. Moreover, a corresponding operation can be further performed.

The invention is directed to a touch sensing system by which a touch gesture is defined based on an area change generated when an object touches a touch interface. Moreover, a corresponding operation can be further performed.

In the invention, a touch sensing method suitable for a touch sensing system is provided. The touch sensing system includes a touch interface. The touch sensing method includes following steps. At least one area change generated on the touch interface by at least one object is sensed within a timing tolerance. A touch gesture corresponding to the at least one object is defined based on the at least one area change.

According to an embodiment of the invention, the step of sensing the at least one area change includes the following. A first area generated on the touch interface is sensed by the at least one object. Whether the first area is greater than a touch threshold is determined. The first area is determined to be a touch area if the first area is greater than the touch threshold.

According to an embodiment of the invention, the step of sensing the at least one area change further includes the following. A second area generated on the touch interface is sensed by the at least one object. Whether a difference between the first area and the second area is greater than at least one variation threshold is determined. The at least one area change is determined to be generated on the touch interface by the at least one object if the difference is greater than the at least one variation threshold.

According to an embodiment of the invention, the step of sensing the at least one area change further includes the following. Whether the first area is greater than or smaller than the second area is determined. The at least one area change is defined as an area increment if the first area is smaller than the second area and if the difference is greater than a first variation threshold. By contrast, the at least one area change is defined as an area decrement if the first area is greater than the second area and if the difference is greater than a second variation threshold.

According to an embodiment of the invention, in the step of defining the touch gesture corresponding to the at least one object, the touch gesture corresponding to the at least one object is defined according to at least one area increment and at least one area decrement.

According to an embodiment of the invention, in the step of defining the touch gesture corresponding to the at least one object, the at least one object refers to a plurality of the objects, and the touch gesture corresponding to the plurality of objects is defined according to at least one area increment or at least one area decrement.

According to an embodiment of the invention, in the step of defining the touch gesture corresponding to the at least one object, the at least one object refers to a plurality of the objects, and the touch gesture corresponding to the plurality of objects is defined according to at least one area increment and at least one area decrement.

According to an embodiment of the invention, the touch sensing method further includes performing a touch operation based on the touch gesture.

In the invention, a touch sensing system including a touch interface and a control unit is provided. The touch interface senses at least one area change generated on the touch interface by at least one object within a timing tolerance. The control unit defines a touch gesture corresponding to the at least one object based on the at least one area change.

According to an embodiment of the invention, when the touch interface senses the at least one area change, the touch interface senses a first area generated on the touch interface by the at least one object, and the control unit determines whether the first area is greater than a touch threshold. The control unit determines the first area to be a touch area if the first area is greater than the touch threshold.

According to an embodiment of the invention, when the touch interface senses the at least one area change, the touch interface senses a second area generated on the touch interface by the at least one object, and the control unit determines whether a difference between the first area and the second area is greater than at least one variation threshold. The control unit determines that the at least one area change is generated on the touch interface by the at least one object if the difference is greater than the at least one variation threshold.

According to an embodiment of the invention, when the control unit determines the at least one area change, the control unit further determines whether the first area is greater than or smaller than the second area. The control unit defines the at least one area change as an area increment if the first area is smaller than the second area and if the difference is greater than a first variation threshold. By contrast, the control unit defines the at least one area change as an area decrement if the first area is greater than the second area and if the difference is greater than a second variation threshold.

According to an embodiment of the invention, the control unit defines the touch gesture corresponding to the at least one object according to at least one area increment and at least one area decrement.

According to an embodiment of the invention, the at least one object refers to a plurality of the objects, and the touch interface senses the at least one area change generated on the touch interface by the plurality of objects within the timing tolerance.

According to an embodiment of the invention, the control unit defines the touch gesture corresponding to the plurality of objects according to at least one area increment of the objects or at least one area decrement of the objects.

According to an embodiment of the invention, the control unit defines the touch gesture corresponding to the plurality of objects according to at least one area increment of the objects and at least one area decrement of the objects.

According to an embodiment of the invention, the control unit performs a touch operation based on the touch gesture.

Based on the above, the touch sensing system described in the embodiments of the invention defines a touch gesture according to an area change generated when at least one object touches a touch interface. Thereby, a corresponding operation can be further performed. From users' perspective, the touch sensing method described in the embodiments of the invention employs a pseudo three-dimensional touch sensing technology, such that the touch sensing technology can be applied in a diverse manner.

It is to be understood that both the foregoing general descriptions and the following detailed embodiments are exemplary and are, together with the accompanying drawings, intended to provide further explanation of technical features and advantages of the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A and FIG. 1B are schematic views illustrating a user's finger touches a touch interface.

FIG. 1C is a schematic view illustrating an area where a user's finger touches a touch interface.

FIG. 1D and FIG. 1E illustrate time frames during which area changes are sensed by a touch sensing system within a timing tolerance according to an embodiment of the invention.

FIG. 2 is a block circuit diagram illustrating a touch sensing system according to an embodiment of the invention.

FIG. 3-FIG. 8 illustrate an area where a user's finger touches a touch interface is changed together with time according to several embodiments of the invention.

FIG. 9A-FIG. 9D illustrate multi-touch area changes according to an embodiment of the invention.

FIG. 10A-FIG. 10D illustrate multi-touch area changes according to another embodiment of the invention.

FIG. 11 is a flowchart illustrating a touch sensing method according to an embodiment of the invention.

### DESCRIPTION OF EMBODIMENTS

In the embodiments provided hereinafter, a touch panel exemplarily acts as a touch interface, and a user's finger exemplarily serves as an object. People having ordinary skill in the art are aware that the touch panel and the user's finger do not pose a limitation on the touch interface and the object of the invention. In other words, any object and any interface with a touch sensing function fall within the protection scope of the invention.

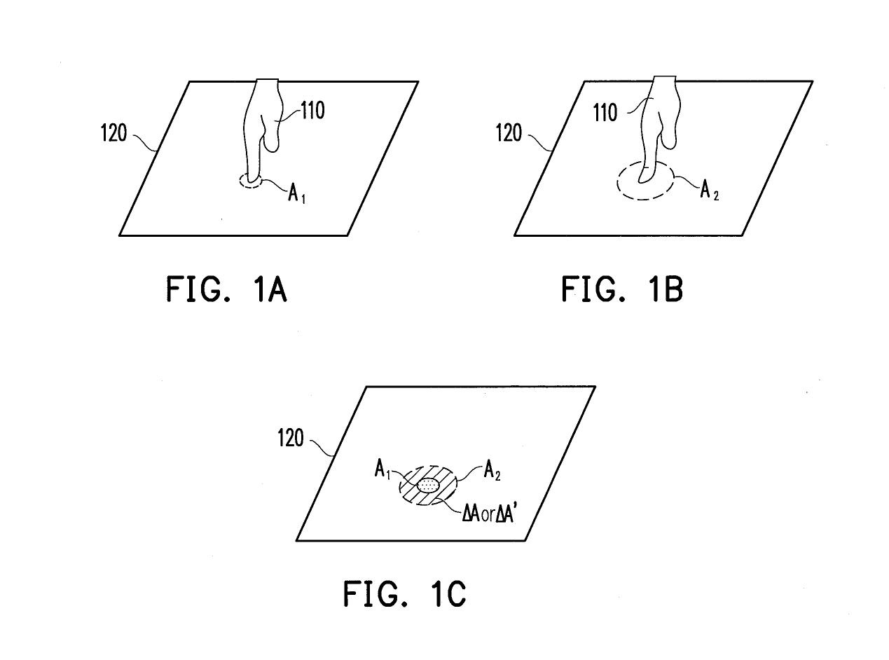

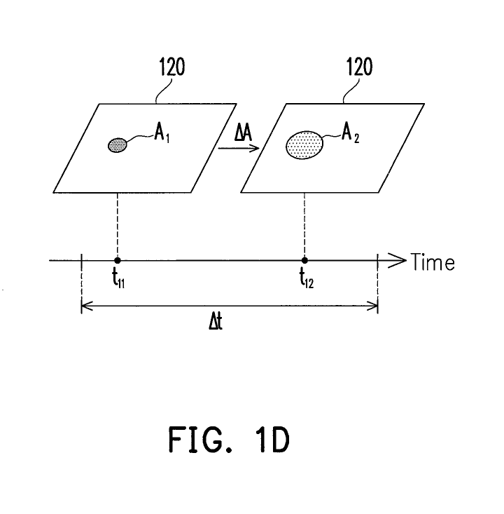

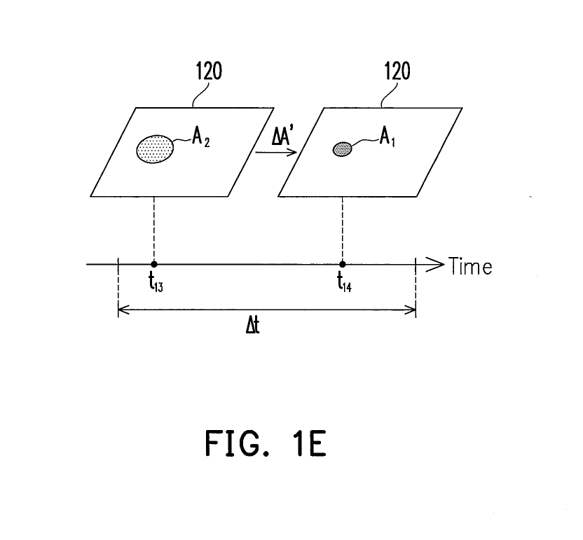

FIG. 1A and FIG. 1B are schematic views illustrating a user's finger touches a touch interface. FIG. 1C is a schematic view illustrating an area where a user's finger touches a touch interface. In FIG. 1A-FIG. 1C, the area where the user's finger 110 touches the touch interface 120 is an area A₁ shown in FIG. 1C, for example. In FIG. 1B, the area where the user's finger 110 touches the touch interface 120 is an area A₂ shown in FIG. 1C, for example. Here, the touch interface 120 is, for example, a touch panel. To better describe the invention, the area A₁ and the area A₂ where the user's finger 110 touches the touch interface 120 in FIG. 1A and FIG. 1B are not illustrated to scale.

FIG. 1D and FIG. 1E illustrate time frames during which area changes are sensed by a touch sensing system within a timing tolerance Δt according to an embodiment of the invention. Please refer to FIG. 1A-FIG. 1E. At timing t₁₁ indicated in FIG. 1D, how the user's finger 110 touches the touch interface 120 is shown in FIG. 1A, for example. Here, the area sensed by the touch interface 120 is the area A₁, for example. At timing t₁₂, how the user's finger 110 touches the touch interface 120 is shown in FIG. 1B, for example. Here, the area sensed by the touch interface 120 is the area A₂, for example.

The area A₁ is, for instance, smaller than the area A₂, and an area change (i.e. a difference between the area A₁ and the area A₂) is ΔA. In this embodiment, the area change ΔA can be defined as an area increment because the area A₁ is smaller than the area A₂. That is to say, within the timing t₁₁-t₁₂, the area A₁ where the user's finger 110 touches the touch interface 120 is expanded to be the area A₂, and the difference between the area A₁ and the area A₂ is the area change ΔA.

Likewise, at timing t₁₃ indicated in FIG. 1E, how the user's finger 110 touches the touch interface 120 is shown in FIG. 1B, for example. At timing t₁₄, how the user's finger 110 touches the touch interface 120 is shown in FIG. 1A, for example. That is to say, within the timing t₁₃-t₁₄ shown in FIG. 1E, the area A₂ where the user's finger 110 touches the touch interface 120 is reduced to be the area A₁, and the area change ΔA′ can be defined as an area decrement.

Note that within the timing t₁₁-t₁₂ or the timing t₁₃-t₁₄, even though the area where the user's finger 110 touches the touch interface 120 is altered, the user's finger 110 keeps on touching the touch interface 120 in this embodiment.

In the following embodiments, when the area where the user's finger touches the touch interface is increased (as shown in FIG. 1D), the area change is defined as the area increment; when the area where the user's finger touches the touch interface is decreased (as shown in FIG. 1E), the area change is defined as the area decrement.

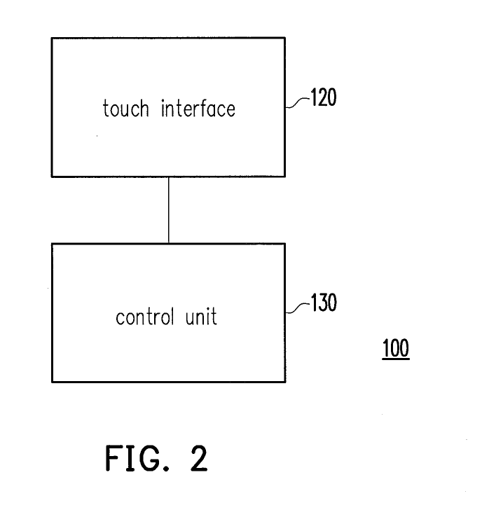

FIG. 2 is a block circuit diagram illustrating a touch sensing system according to an embodiment of the invention. As shown in FIG. 2, the touch sensing system 100 of this embodiment includes a touch interface 120 and a control unit 130. The touch interface 120 senses at least one area change generated on the touch interface 120 by at least one object within a timing tolerance. The control unit 130 defines a touch gesture corresponding to the object according to the area change sensed by the touch interface 120, so as to perform a touch operation according to the touch gesture.

Specifically, as indicated in FIG. 1A-FIG. 1E and FIG. 2, the touch interface 120 of this embodiment is a touch panel, for example, and the object sensed by the touch interface 120 is the user's finger 110 shown in FIG. 1A, for example.

When the user's finger 110 initially touches the touch interface 120, a first area that is generated on the touch interface 120 by the user's finger 110 is sensed by the touch interface 120. For instance, if the user's finger 110 touches the touch interface 120 at the timing t₁₁, and how the user's finger 110 touches the touch interface 120 is as shown in FIG. 1A, the first area sensed by the touch interface 120 refers to the area A₁ depicted in FIG. 1C.

The control unit 130 then determines whether the area A₁ is greater than a touch threshold. If the area A₁ is greater than the touch threshold, the control unit 130 determines the area A₁ to be a touch area, such that the touch sensing method of this embodiment further proceeds.

Accordingly, when the control unit 130 determines the area A₁ to be the touch area, the touch interface 120 senses a second area generated on the touch interface 120 by the user's finger 110 if the area where the user's finger 110 touches the touch interface 120 is changed within a timing tolerance Δt. For instance, if how the user's finger 110 touches the touch interface 120 is changed as shown in FIG. 1B, the second area refers to the area A₂ depicted in FIG. 1C.

The control unit 130 then determines whether a difference between the area A₁ and the area A₂ is greater than a first variation threshold. The control unit 130 determines the area change ΔA is generated on the touch interface 120 by the user's finger 110 if the difference is greater than the first variation threshold.

To be more specific, if how the user's finger 110 touches the touch interface 120 is changed, the control unit 130 not only determines whether the area A₁ is greater than the touch threshold but also determines the area A₁ is greater than or smaller than the area A₂. The control unit 130 defines the area change from the area A₁ to the area A₂ as an area increment if the area A₁ is smaller than the area A₂ and if the difference is greater than a first variation threshold.

Hence, according to this embodiment, the control unit 130 can define a touch gesture corresponding to the user's finger 110 based on at least one area increment and thereby perform a corresponding touch operation.

On the other hand, the control unit 130 defines the area change ΔA′ between the area A₁ and the area A₂ as an area decrement according to this embodiment if how the user's finger 110 touches the touch interface 120 is altered as shown in FIG. 1E.

Hence, in this embodiment, the control unit 130 can define another touch gesture corresponding to the user's finger 110 based on at least one area decrement and thereby perform another corresponding touch operation.

The exemplary area increment depicted in FIG. 1D and the exemplary area decrement depicted in FIG. 1E have an equivalent value according to this embodiment, which should not be construed as a limitation to this invention. According to other embodiments, the control unit 130 can define a touch gesture corresponding to the user's finger 110 based on the area increment and the area decrement having different values and thereby perform a corresponding touch operation.

In addition, the first area of this embodiment refers to the area where the user's finger 110 initially touches the touch interface 120. By contrast, the second area of this embodiment refers to an area where the user's finger 110 touches the touch interface 120 in a different manner.

For instance, in FIG. 1D, the first area refers to the area A₁ where the user's finger 110 touches the touch interface 120 at timing t₁₁. The second area refers to an area A₂ where the user's finger 110 touches the touch interface 120 in a different manner at timing t₁₂.

On the contrary, in FIG. 1E, the first area refers to the area A₂ where the user's finger 110 touches the touch interface 120 at timing t₁₃. The second area refers to the area A₁ where the user's finger 110 touches the touch interface 120 in a different manner at timing t₁₄.

Note that when the control unit 130 determines the area change between the area A₁ and the area A₂ to be the area increment or the area decrement, the determination can be based on the same variation threshold or different variation thresholds. According to this embodiment, the control unit 130 determines the area change to be the area increment or the area decrement based on the first variation threshold and the second variation threshold, respectively, which should not be construed as a limitation to this invention.

Besides, in this embodiment, the control unit 130 defines the touch gesture corresponding to the user's finger 110 within a timing tolerance Δt based on at least one area increment or at least one area decrement, which should not be construed as a limitation to this invention.

The control unit 130 in other embodiments can also define the touch gesture corresponding to the user's finger 110 within a timing tolerance Δt based on at least one area increment and at least one area decrement.

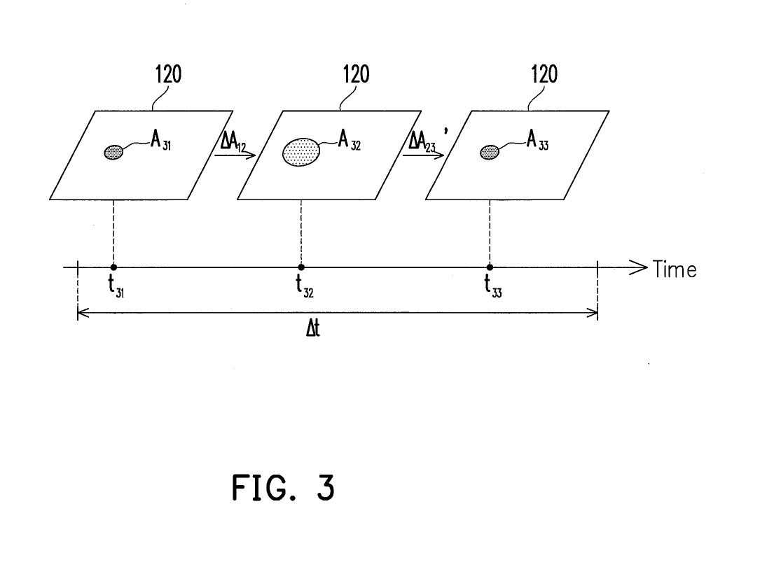

FIG. 3 illustrates that an area where a user's finger touches a touch interface is changed together with time according to an embodiment of the invention. As shown in FIG. 2 and FIG. 3, the control unit 130 of this embodiment defines the touch gesture corresponding to the user's finger 110 within a timing tolerance Δt based on an area increment and an area decrement.

In particular, if an area A₃₁ where the user's finger 110 touches the touch interface 120 is greater than a touch threshold, the touch sensing method of this embodiment is applied by the touch sensing system 100.

Within the timing t₃₁-t₃₂, the area A₃₁ where the user's finger 110 touches the touch interface 120 is expanded to be the area A₃₂. If a difference (i.e. an area change ΔA₁₂) between the area A₃₁ and the area A₃₂ is greater than a first variation threshold, the control unit 130 defines the area change ΔA₁₂ as an area increment within a timing tolerance Δt.

Within the timing t₃₂-t₃₃, the area A₃₂ where the user's finger 110 touches the touch interface 120 is reduced to be the area A₃₃. If a difference (i.e. an area change ΔA₂₃′) between the area A₃₂ and the area A₃₃ is greater than a second variation threshold, the control unit 130 defines the area change ΔA₂₃′ as an area decrement within a timing tolerance Δt.

Hence, according to this embodiment, the control unit 130 can define a touch gesture corresponding to the user's finger 110 based on an area increment and an area decrement within a timing tolerance Δt and thereby perform a corresponding touch operation. In other words, the control unit 130 of this embodiment defines the touch gesture corresponding to the user's finger 110 within a timing tolerance Δt based on the touch area which is first increased and then decreased.

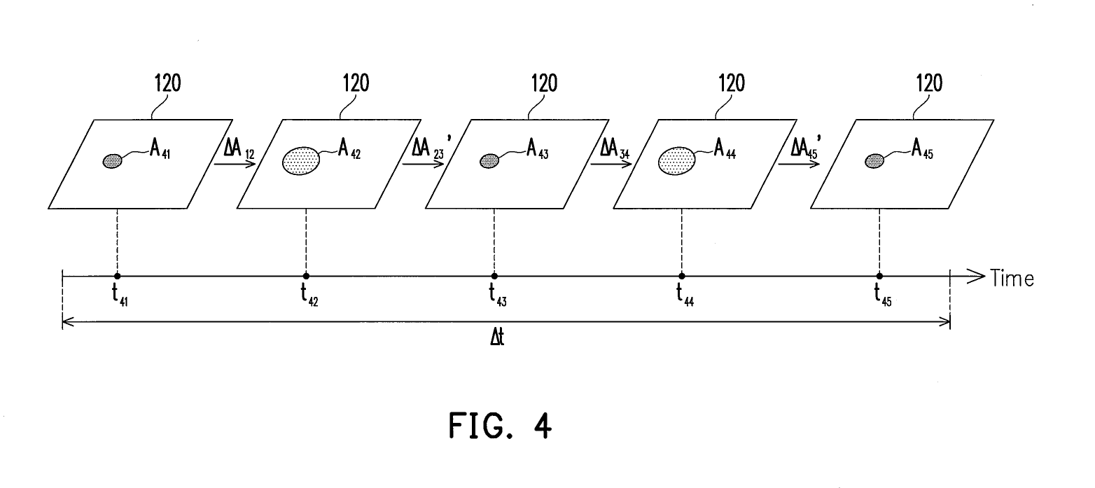

FIG. 4 illustrates that an area where a user's finger touches a touch interface is changed together with time according to another embodiment of the invention. As shown in FIG. 2 and FIG. 4, the control unit 130 of this embodiment defines the touch gesture corresponding to the user's finger 110 within a timing tolerance Δt based on two area increments and two area decrements.

In this embodiment, the area where the user's finger 110 touches the touch interface 120 is sequentially changed to an area A₄₁, an area A₄₂, an area A₄₃, an area A₄₄, and an area A₄₅ together with time. Within a timing tolerance Δt, the control unit 130 sequentially defines an area change ΔA₁₂, an area change ΔA₂₃′, an area change ΔA₃₄, and an area change ΔA₄₅′ as an area increment, an area decrement, an area increment, and an area decrement.

Accordingly, the control unit 130 of this embodiment defines the touch gesture corresponding to the user's finger 110 within a timing tolerance Δt based on the touch area which is sequentially increased, decreased, increased, and decreased.

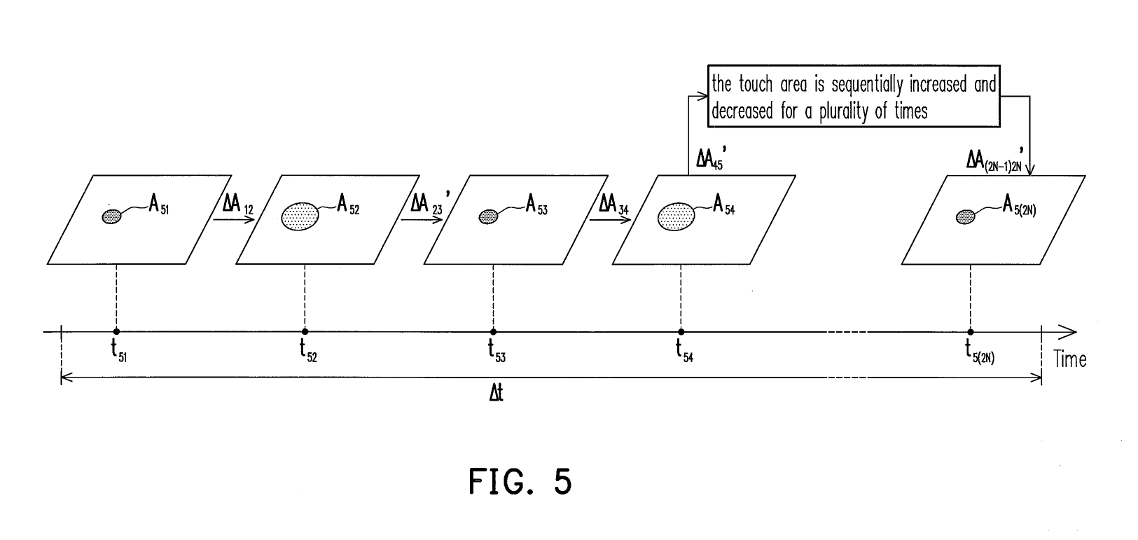

FIG. 5 illustrates that an area where a user's finger touches a touch interface is changed together with time according to another embodiment of the invention. As shown in FIG. 2 and FIG. 5, the control unit 130 of this embodiment defines the touch gesture corresponding to the user's finger 110 within a timing tolerance Δt based on a plurality of area increments and a plurality of area decrements.

For instance, the control unit 130 of this embodiment defines the touch gesture corresponding to the user's finger 110 within a timing tolerance Δt based on the touch area which is sequentially increased and decreased for N times. Here, N is greater than or equal to 3, for example.

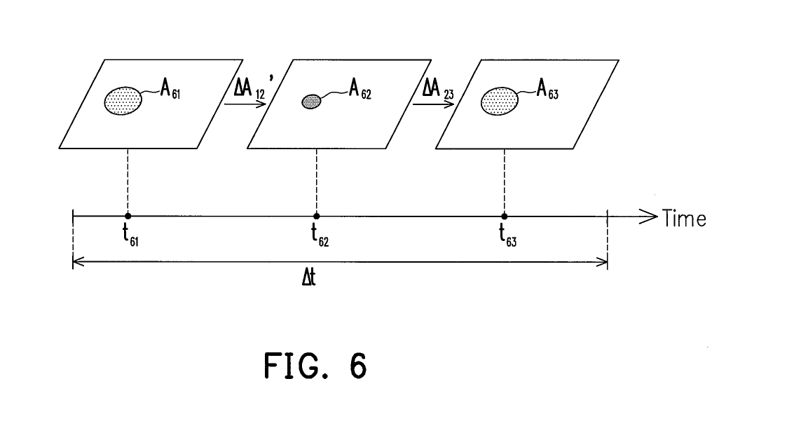

FIG. 6 illustrates that an area where a user's finger touches a touch interface is changed together with time according to another embodiment of the invention. As shown in FIG. 2 and FIG. 6, the control unit 130 of this embodiment defines the touch gesture corresponding to the user's finger 110 within a timing tolerance Δt based on an area decrement and an area increment.

In this embodiment, the area where the user's finger 110 touches the touch interface 120 is sequentially changed to an area A₆₁, an area A₆₂, and an area A₆₃ together with time. Within a timing tolerance Δt, the control unit 130 sequentially defines an area change ΔA₁₂′ and an area change ΔA₂₃ as an area decrement and an area increment.

Accordingly, the control unit 130 of this embodiment defines the touch gesture corresponding to the user's finger 110 within a timing tolerance Δt based on the touch area which is first decreased and then increased.

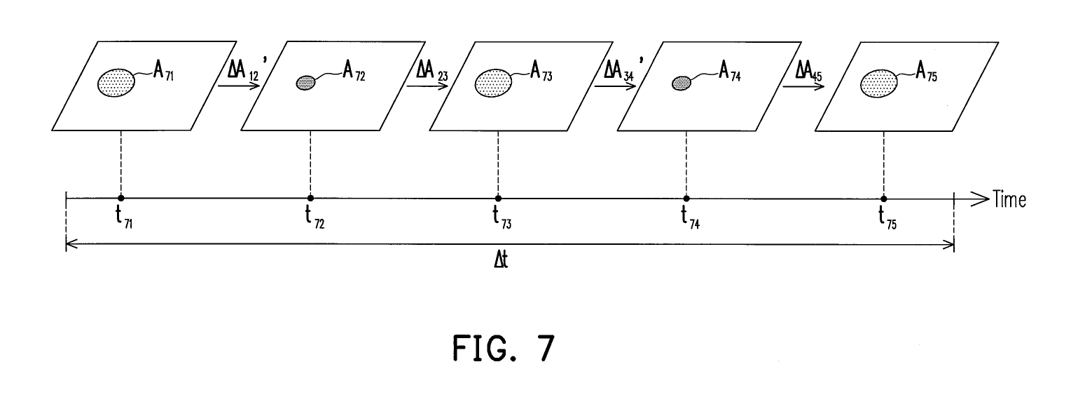

FIG. 7 illustrates that an area where a user's finger touches a touch interface is changed together with time according to another embodiment of the invention. As shown in FIG. 2 and FIG. 7, the control unit 130 of this embodiment defines the touch gesture corresponding to the user's finger 110 within a timing tolerance Δt based on two area decrements and two area increments.

In this embodiment, the area where the user's finger 110 touches the touch interface 120 is sequentially changed to an area A₇₁, an area A₇₂, an area A₇₃, an area A₇₄, and an area A₇₅ together with time. Within a timing tolerance Δt, the control unit 130 sequentially defines an area change ΔA₁₂′, an area change ΔA₂₃, an area change ΔA₃₄′, and an area change ΔA₄₅ as an area decrement, an area increment, an area decrement, and an area increment.

Accordingly, the control unit 130 of this embodiment defines the touch gesture corresponding to the user's finger 110 within a timing tolerance Δt based on the touch area which is sequentially decreased, increased, decreased, and increased.

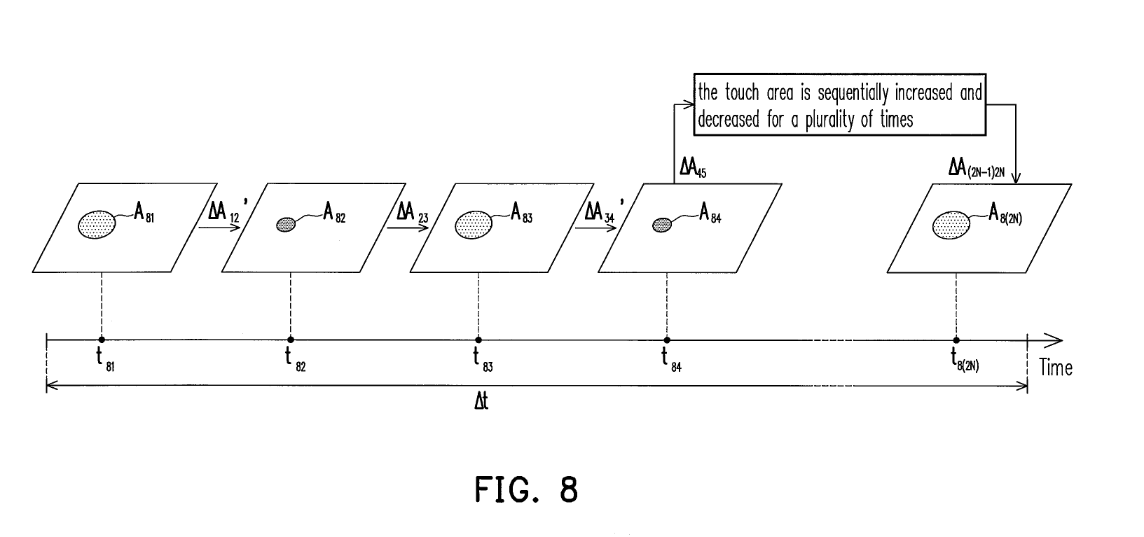

FIG. 8 illustrates that an area where a user's finger touches a touch interface is changed together with time according to another embodiment of the invention. As shown in FIG. 2 and FIG. 8, the control unit 130 of this embodiment defines the touch gesture corresponding to the user's finger 110 within a timing tolerance Δt based on a plurality of area decrements and a plurality of area increments.

For instance, the control unit 130 of this embodiment defines the touch gesture corresponding to the user's finger 110 within a timing tolerance Δt based on the touch area which is sequentially decreased and increased for N times. Here, N is greater than or equal to 3, for example.

Note that even though the area where the user's finger 110 touches the touch interface 120 is altered in the embodiments depicted in FIG. 3-FIG. 8, the user's finger 110 keeps on touching the touch interface 120. Besides, in the embodiments depicted in FIG. 3-FIG. 8, the area increments of different touch areas can be the same or different, and so can be the area decrements of different touch areas.

Moreover, in the embodiments depicted in FIG. 3-FIG. 8, when the control unit 130 defines the touch gesture corresponding to the user's finger 110 within a timing tolerance Δt based on at least one area increment and at least one area decrement, the area increment and the area decrement are arranged in an alternate sequence together with change of time no matter the touch area is first increased and then decreased for at least one time or the touch area is first decreased and then increased for at least one time, which should not be construed as a limitation to this invention. The control unit 130 can define the touch gesture corresponding to the user's finger 110 within a timing tolerance Δt based on at least one area increment and at least one area decrement arranged in various manner.

On the other hand, in the embodiments depicted in FIG. 3-FIG. 8, the touch gesture defined by the control unit 130 can be the same or different. Namely, the control unit 130 can define the same touch gesture or different touch gestures corresponding to the user's finger 110 within a timing tolerance Δt based on at least one area increment and at least one area decrement arranged in various manner.

For instance, the touch gesture defined by the control unit 130 based on the touch area which is sequentially decreased, increased, decreased, and increased can be the same as or different from the touch gesture defined by the control unit 130 based on the touch area which is sequentially increased, decreased, increased, and decreased. In an alternative, the touch gesture defined by the control unit 130 based on the touch area which is first decreased and then increased can be the same as or different from the touch gesture defined by the control unit 130 based on the touch area which is sequentially decreased, increased, decreased, and increased.

In the embodiments depicted in FIG. 1A-FIG. 8, the touch sensing system 100 exemplarily senses the single-touch area change, which is not limited in this invention. The touch sensing system 100 in other embodiments can further sense the multi-touch area change in order to define the touch gesture corresponding to the user's finger.

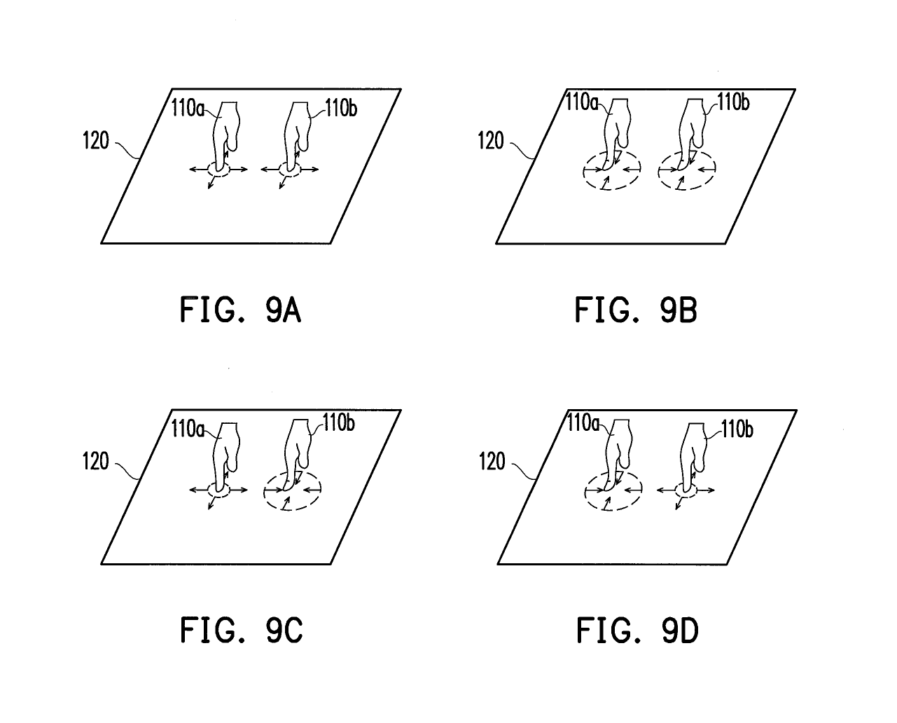

FIG. 9A-FIG. 9D illustrate multi-touch area changes according to an embodiment of the invention. The area where the user's finger touches the touch interface in FIG. 9A-FIG. 9D is not illustrated to scale.

Please refer to FIG. 1C-FIG. 1E, FIG. 2, and FIG. 9A-9D. If arrows located at the boundary of the contact area as depicted in FIG. 9A-9D all point at a direction away from the center of the circular contact area, the area change of the contact area as shown in FIG. 1C and FIG. 1D refers to an area increment. By contrast, if arrows located at the boundary of the contact area all point at the center of the circular contact area, the area change of the contact area as shown in FIG. 1C and FIG. 1E refers to an area decrement.

The control unit 130 in FIG. 9A-FIG. 9B defines the touch gesture corresponding to a plurality of objects according to at least one area increment or at least one area decrement. Here, the objects are, for example, the user's fingers 110a and 110b.

In FIG. 9A, for example, the control unit 130 defines the touch gesture corresponding to the user's fingers 110a and 110b according to two different touch areas which are both increased. Note that the area increments of the two different touch areas can be equal or different in this embodiment.

Similarly, in FIG. 9B, the control unit 130 defines the touch gesture corresponding to the user's fingers 110a and 110b according to two different touch areas which are both decreased. Note that the area decrements of the two different touch areas can be equal or different in this embodiment.

The control unit 130 in FIG. 9C-FIG. 9D defines the touch gesture corresponding to a plurality of objects according to at least one area increment and at least one area decrement. Here, the objects are, for example, the user's fingers 110a and 110b.

In FIG. 9C and FIG. 9D, for example, the control unit 130 defines the touch gesture corresponding to the user's fingers 110a and 110b according to two different touch areas, wherein one of the two touch areas is increased, and the other is decreased. Note that the area increment and the area decrement of the two different touch areas can be equal or different in this embodiment.

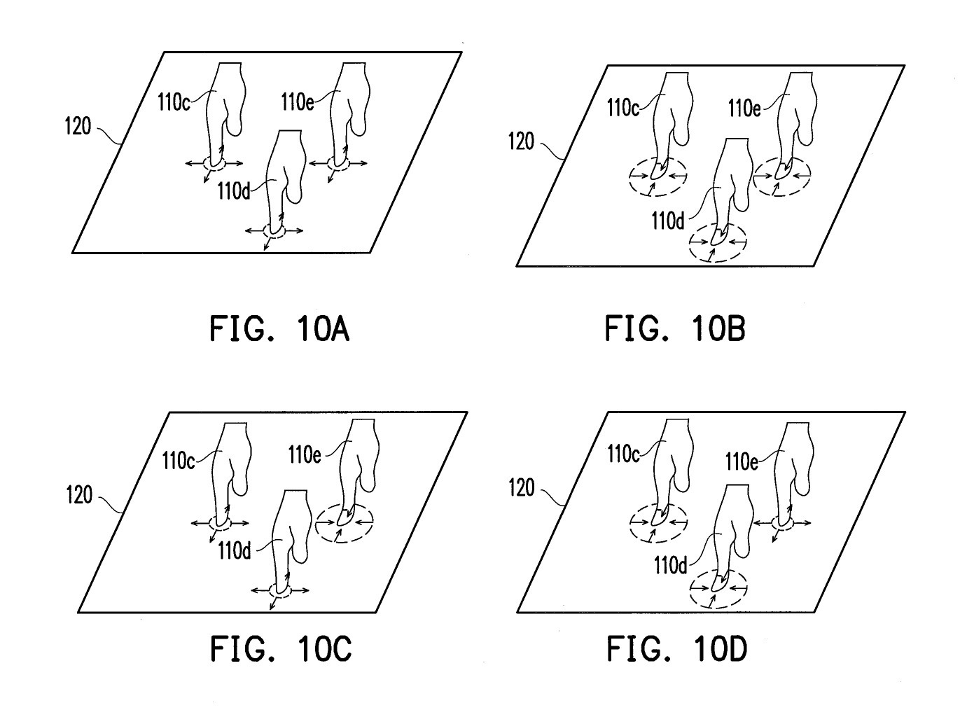

FIG. 10A-FIG. 10D illustrate multi-touch area changes according to another embodiment of the invention. The area where the user's finger touches the touch interface in FIG. 10A-FIG. 10D is not illustrated to scale.

Please refer to FIG. 2, and FIG. 10A-10D. The control unit 130 in FIG. 10A-FIG. 10B defines the touch gesture corresponding to user's fingers 110c, 110d, and 110e according to at least one area increment or at least one area decrement.

In FIG. 10A, for example, the control unit 130 defines the touch gesture corresponding to the user's fingers 110c, 110d, and 110e according to three different touch areas which are all increased. Note that the area increments of the three different touch areas can be equal or different in this embodiment.

Similarly, in FIG. 10B, the control unit 130 defines the touch gesture corresponding to the user's fingers 110c, 110d, and 110e according to three different touch areas which are all decreased. Note that the area decrements of the three different touch areas can be equal or different in this embodiment.

The control unit 130 in FIG. 10C-FIG. 10D defines the touch gesture corresponding to the user's fingers 110c, 110d, and 110e according to at least one area increment and at least one area decrement.

In FIG. 10C, for example, the control unit 130 defines the touch gesture corresponding to the user's fingers 110c, 110d, and 110e according to three different touch areas, wherein one of the three touch areas is decreased, and the others are increased. Note that the two area increments and the area decrement of the three different touch areas can be equal or different in this embodiment.

Likewise, in FIG. 10D, the control unit 130 defines the touch gesture corresponding to the user's fingers 110c, 110d, and 110e according to three different touch areas, wherein one of the three touch areas is increased, and the others are decreased. Note that the two area decrements and the area increment of the three different touch areas can be equal or different in this embodiment.

On the other hand, in the embodiments depicted in FIG. 9A-FIG. 10D, the touch gesture defined by the control unit 130 can be the same or different. Namely, the control unit 130 can define the same touch gesture or different touch gestures corresponding to the objects within a timing tolerance Δt based on at least one area increment and/or at least one area decrement arranged in various manner.

Besides, according to the embodiments of the invention, the dimension and the shape of the contact area and the dimension and the shape of the area change as depicted in FIG. 1A-FIG. 10D are all exemplary and are not intended to limit the invention.

The area where the object touches the touch interface is circular or elliptical in the above embodiments, while people skilled in the art are aware that the area where the object touches the touch interface in any shape falls within the protection scope of the invention.

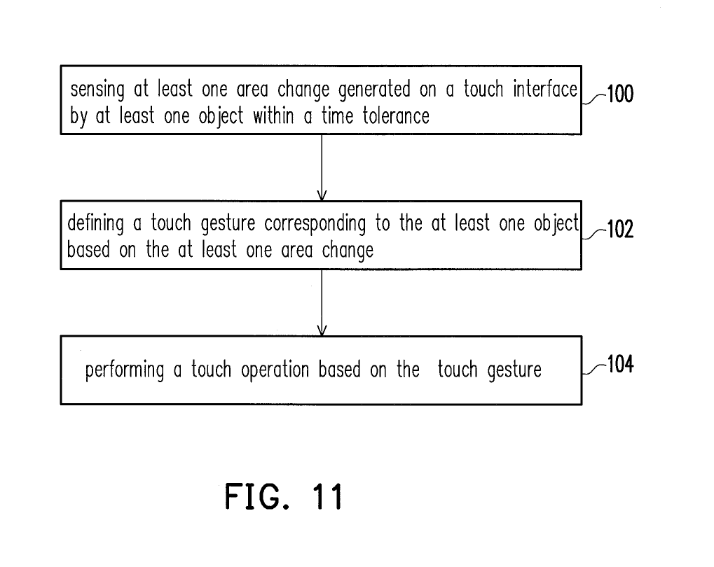

FIG. 11 is a flowchart illustrating a touch sensing method according to an embodiment of the invention. With reference to FIG. 2 and FIG. 11, the touch sensing method of this embodiment includes following steps. In step S100, at least one area change generated on a touch interface 120 by at least one object (e.g. a user's finger) is sensed within a timing tolerance Δt. In step S102, a touch gesture corresponding to the at least one object is defined based on the at least one area change. In step S104, a touch operation is performed based on the touch gesture.

The touch sensing method described in this embodiment of the invention is sufficiently taught, suggested, and embodied in the embodiments illustrated in FIG. 1A-FIG. 10D, and therefore no further description is provided herein.

In light of the foregoing, the touch sensing system described in the embodiments of the invention defines a touch gesture according to an area change generated on a touch interface when an object touches the touch interface. Thereby, a corresponding operation can be further performed. Besides, the touch sensing system not only can sense single-touch area change but also can sense multi-touch area change in order to define the touch gesture corresponding to the object. From users' perspective, the touch sensing method described in the embodiments of the invention employs a pseudo three-dimensional touch sensing technology, such that applications of the touch sensing technology become more diverse.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A touch sensing method suitable for a touch sensing system, the touch sensing system comprising a touch interface, the touch sensing method comprising:
sensing at least one area change generated on the touch interface by at least one object within a timing tolerance; and
defining a touch gesture corresponding to the at least one object based on the at least one area change.

2. The touch sensing method as claimed in claim 1, the step of sensing the at least one area change comprising:
sensing a first area generated on the touch interface by the at least one object;
determining whether the first area is greater than a touch threshold; and
determining the first area to be a touch area if the first area is greater than the touch threshold.

3. The touch sensing method as claimed in claim 2, the step of sensing the at least one area change further comprising:
sensing a second area generated on the touch interface by the at least one object;
determining whether a difference between the first area and the second area is greater than at least one variation threshold; and
determining the at least one area change to be generated on the touch interface by the at least one object if the difference is greater than the at least one variation threshold.

4. The touch sensing method as claimed in claim 3, the step of sensing the at least one area change further comprising:
determining whether the first area is greater than or smaller than the second area;
defining the at least one area change as an area increment if the first area is smaller than the second area and if the difference is greater than a first variation threshold; and
defining the at least one area change as an area decrement if the first area is greater than the second area and if the difference is greater than a second variation threshold.

5. The touch sensing method as claimed in claim 4, wherein in the step of defining the touch gesture corresponding to the at least one object, the touch gesture corresponding to the at least one object is defined according to at least one of the area increments and at least one of the area decrements.

6. The touch sensing method as claimed in claim 4, wherein in the step of defining the touch gesture corresponding to the at least one object, the at least one object refers to a plurality of the objects, and the touch gesture corresponding to the plurality of objects is defined according to at least one of the area increments or at least one of the area decrements.

7. The touch sensing method as claimed in claim 4, wherein in the step of defining the touch gesture corresponding to the at least one object, the at least one object refers to a plurality of the objects, and the touch gesture corresponding to the plurality of objects is defined according to at least one of the area increments and at least one of the area decrements.

8. The touch sensing method as claimed in claim 1, further comprising:
performing a touch operation based on the touch gesture.

9. A touch sensing system comprising:
a touch interface sensing at least one area change generated on the touch interface by at least one object within a timing tolerance; and
a control unit defining a touch gesture corresponding to the at least one object based on the at least one area change.

10. The touch sensing system as claimed in claim 9, wherein the touch interface senses a first area generated on the touch interface by the at least one object when the touch interface senses the at least one area change, the control unit determines whether the first area is greater than a touch threshold, and the control unit determines the first area to be a touch area if the first area is greater than the touch threshold.

11. The touch sensing system as claimed in claim 10, wherein the touch interface senses a second area generated on the touch interface by the at least one object when the touch interface senses the at least one area change, the control unit determines whether a difference between the first area and the second area is greater than at least one variation threshold, and the control unit determines that the at least one area change is generated on the touch interface by the at least one object if the difference is greater than the at least one variation threshold.

12. The touch sensing system as claimed in claim 11, wherein the control unit further determines whether the first area is greater than or smaller than the second area when the control unit determines the at least one area change, the control unit defines the at least one area change as an area increment if the first area is smaller than the second area and if the difference is greater than a first variation threshold, and the control unit defines the at least one area change as an area decrement if the first area is greater than the second area and if the difference is greater than a second variation threshold.

13. The touch sensing system as claimed in claim 12, wherein the control unit defines the touch gesture corresponding to the at least one object according to at least one of the area increments and at least one of the area decrements.

14. The touch sensing system as claimed in claim 12, wherein the at least one object refers to a plurality of the objects, and the touch interface senses the at least one area change generated on the touch interface by the plurality of objects within the timing tolerance.

15. The touch sensing system as claimed in claim 14, wherein the control unit defines the touch gesture corresponding to the plurality of objects according to at least one of the area increments of the objects or at least one of the area decrements of the objects.

16. The touch sensing system as claimed in claim 14, wherein the control unit defines the touch gesture corresponding to the plurality of objects according to at least one of the area increments of the objects and at least one of the area decrements of the objects.

17. The touch sensing system as claimed in claim 9, wherein the control unit performs a touch operation based on the touch gesture.
